(19) United States
(12) Patent Application Publication
(10) Pub. No.: US 2025/0292330 A1
(43) Pub. Date: Sep. 18, 2025

(54) MULTIMODAL FOUNDATION MODEL FOR TIME SERIES DATA

(71) Applicant: Goldman Sachs & Co. LLC, New York, NY (US)

(72) Inventors: Bing Xiang, Mount Kisco, NY (US); Eliot Brenner, Westfield, NJ (US); Frank Long, New York, NY (US); Lyson Njoroge, London (GB); Qian Zhao, Great Neck, NY (US); Matteo Pozzi, London (GB); Pingping Chen, Hong Kong (HK); Dimitrios Tsementzis, New York, NY (US)

(21) Appl. No.: 19/076,771

(22) Filed: Mar. 11, 2025

(30) Foreign Application Priority Data
Mar. 14, 2024 (GR) 20240100192

(51) Int. Cl. G06Q 40/06; G06N 3/045

(52) U.S. Cl. CPC G06Q 40/06; G06N 3/045

(57) ABSTRACT

A foundation model is trained on time series-related data. The foundation model is configured to take as input time series data (e.g., asset prices in a market, power demand in a power grid, scores in baseball games, etc.) as well as related time-stamped exogenous data having a different modality from the time-series data (e.g., news headlines). Once the foundation model is trained, it may be fine-tuned for different decoder heads to make predictions for a range of time series values.

### CROSS-REFERENCE TO RELATED APPLICATIONS

This application claims priority to Greek Patent Application No. 20240100192, entitled “Multimodal Foundation Model for Time Series Data,” which was filed on Mar. 14, 2024, which is incorporated by reference.

### BACKGROUND

### 1. Technical Field

The subject matter described relates generally to machine-learning and, in particular, to predicting future values in time series data using a machine-learning model that takes time series data and time-stamped text as input.

### 2. Background Information

There are a wide range of scenarios in which predicting the next value in a time series is useful. For example, prices of a stock, bond, or other asset over time form a time series. Being able to predict future values in the time series (i.e., future values of the asset) is of interest in many financial settings. As another example, in power grid management, predicting future demand is critical in managing power infrastructure effectively. Existing approaches for extrapolating future values from past data can be effective in learning patterns over time but lack any understanding of the underlying causes of those patterns. Put another way, existing approaches typically lack context for the predictions made.

### SUMMARY

A multimodal foundation model is trained on time series-related data. The foundation model is configured to take as input time series data (e.g., power demand in a power grid, asset prices in a market, scores in baseball games, etc.) as well as time-stamped exogenous data of a different modality (e.g., text news headlines, photographs from news articles, videos from news broadcasts, audio from radio shows, etc.). Once the foundation model is trained, it may be fine-tuned for different decoder heads to make predictions for a range of time series-related values. For example, a foundation model trained on market data may be fine-tuned to provide predictions of future prices of assets, volumes of assets traded, volatilities of asset prices, or any other desired parameters of the market that varies over time.

### BRIEF DESCRIPTION OF THE DRAWINGS

FIG. 1 is a block diagram of a networked computing environment suitable for providing time series predictions using a foundation model, according to one embodiment.

FIG. 2 is a block diagram of the server shown in FIG. 1, according to one embodiment.

FIGS. 3A through 3C illustrate a transformer architecture for analyzing time series data that may be modified to also accept text (or other modalities) of input, according to one embodiment.

FIGS. 4A and 4B are pseudocode illustrating the operation of a transformer, according to one embodiment.

FIG. 5 is a flowchart of a method for generating a time series prediction, according to one embodiment.

FIG. 6 is a block diagram illustrating an example of a computer suitable for use in the networked computing environment of FIG. 1, according to one embodiment.

### DETAILED DESCRIPTION

The figures and the following description describe certain embodiments by way of illustration only. It is noted that wherever practicable similar or like reference numbers are used in the figures to indicate similar or like functionality. Where similar elements are referenced by a common numeral followed by a letter, reference to the numeral alone may refer to any such element or combination of elements, depending on the context. One skilled in the art will readily recognize that alternative embodiments of the structures and methods may be employed without departing from the principles described.

### Overview

A foundation model is trained on time series data from one or more sources (e.g., electricity usage, high and low temperatures, asset prices over time, etc.) and contextual information that is related to the time series data having a different modality from the time series data (e.g., news headlines from one or more sources). The contextual information may be time-stamped (e.g., with the date of publication or date and time of publication). Through training, the foundation model learns a representation of time series and how the time series values and contextual information are interrelated. The foundation model may then be fine-tuned to specific prediction tasks (e.g., predicting the next day price or trading volume of a target asset or assets in a market, predicting the high temperature for the upcoming weekend, or predicting power requirements in a city for the next month, etc.) to be tailored to specific use cases. Because the foundation model already includes a large amount of information about the time series and correlations with the contextual data, this fine-tuning can be performed relatively quickly with a relatively small amount of task-specific training data and computational resources (relative to the time, training data, and computing resources required to initially train the foundation model).

### Example Systems

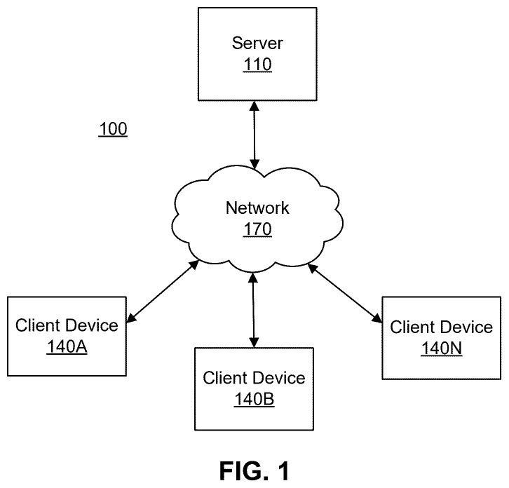

FIG. 1 illustrates one embodiment of a networked computing environment 100 suitable for providing time series predictions using a foundation model. In the embodiment shown in FIG. 1, the networked computing environment 100 includes a server 110 and a set of client devices 140, all connected via a network 170. In other embodiments, the networked computing environment 100 includes different or additional elements. In addition, the functions may be distributed among the elements in a different manner than described. For example, the time series predictions may be provided by a stand-alone system that performs the functionality of both the server 110 and a client device 140.

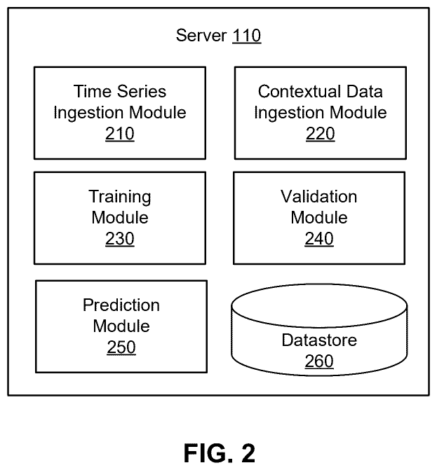

The server 110 makes a trained foundation model available to the client devices 140. The server 110 may train or manage the training (e.g., by a server farm) of the foundation model or may just host a foundation model that was trained by another system. In one embodiment, the foundation model takes historical time series data and time-stamped contextual information as input and outputs a prediction of one or more future time series values. For example, the foundation model may take historical market data and news headlines as input and output a vector representing the current market state. Although the contextual information is described as time-stamped, at prediction time, the contextual information may be current information (e.g., news headlines from the current day or week) and may not be explicitly time stamped. In other words, where the contextual information is current, the time stamp may be implied from the time at which the prediction is being generated. Various embodiments of the server 110 and foundation model are described in greater detail below, with reference to FIG. 2.

The client devices 140 are computing devices capable of receiving user input as well as transmitting and receiving data via the network 170. The client devices 140 can take various forms such as desktop computers, laptop computers, personal digital assistants (PDAs), mobile telephones, smartphones, and other suitable devices. In one embodiment, a client device 140 provides an interface with which users may download the trained foundation model from the server 110, initiate a fine-tuning process on the foundation model to train it for generating predictions for one or more specific variables based on time-series data and time-stamped contextual information, and deploy the fine-tuned foundation model to generate the predictions of the one or more specific variables based on time series data and time-stamped contextual information. The fine-tuning process may include adding a decoder head including one or more additional layers to the foundation model. Once deployed, the fine-tuned foundation model may periodically (e.g., every minute, every hour, once a day, etc.) generate predictions for the next value in one or more time series of interest based on the prior values of the time series and currently available contextual information (e.g., current news headlines).

The network 170 provides the communication channels via which the other elements of the networked computing environment 100 communicate. The network 170 can include any combination of local area and/or wide area networks, using both wired and/or wireless communication systems. In one embodiment, the network 170 uses standard communications technologies and/or protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, all or some of the communication links of the network 170 may be encrypted using any suitable technique or techniques.

FIG. 2 illustrates one embodiment of the server 110. In the embodiment shown, the server 110 includes a time series ingestion module 210, a contextual data ingestion module 220, a training module 230, a validation module 240, a prediction module 250, and a datastore 260. In other embodiments, the server 110 includes different or additional elements. In addition, the functions may be distributed among the elements in a different manner than described.

The times series ingestion module 210 receives time series data and performs any preprocessing desired for use with a predictive model. For example, in the case of applying the model to a financial market, the time series ingestion module 210 may retrieve historical asset price data from a database (e.g., price ticks of an index for twenty years, derivatives, indices, macro indicators like rates, TIPS, etc.) and build a vector representing the data as one or more time series of values. The vector may use an encoding to indicate that some values (e.g., the price of certain assets at certain times) are not available.

The contextual data ingestion module 220 receives contextual data related to the time series and preprocesses it for use with the model. The contextual data may be time stamped to indicate how it correlates chronologically with the time series. Typically, the contextual data has one or more modalities that are different from the modality of the time series data. For example, the time series are typically ordered sets of numerical values, while the contextual data may include one or more of text, images, video, audio data, or any other type of data having a modality other than ordered numerical values. In one embodiment, the contextual data includes time stamped text data, such as dated news headlines.

The training module 230 trains the predictive model using the time series data and contextual data ingested by the server 110. In one embodiment, the training process is modified from a typical “GPT-like” model training process to account for the incorporation of contextual data in modalities other than the expected modality of the time series data. In one embodiment, the model is initialized with the weights of any causal language model such as Llama 2/Mistral7b/Olmo7b, taking away the last layer. Weights may be trained using PEFT/Lora or any other suitable approach in an end-to-end fashion by backpropagating the mean square error loss in PatchTST. A specific embodiment is described below in which the GPT-like model is adapted to accept both time series data and text data, but it should be appreciated that the model may be adapted to accept input data in other modalities using the same or similar techniques.

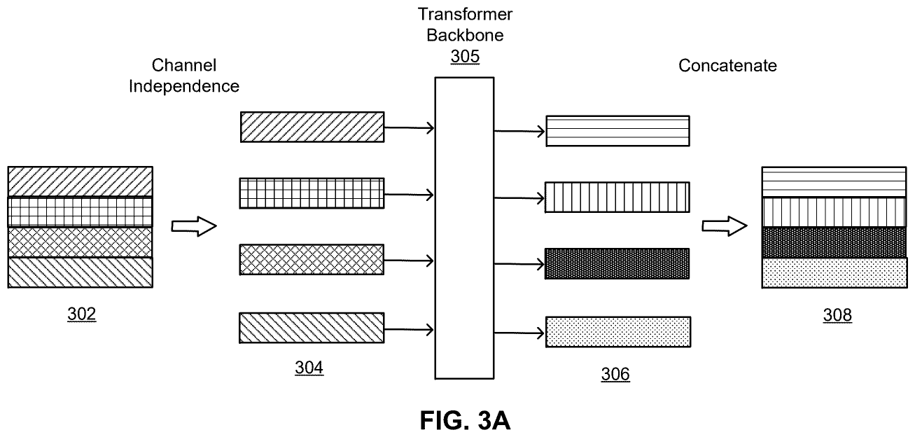

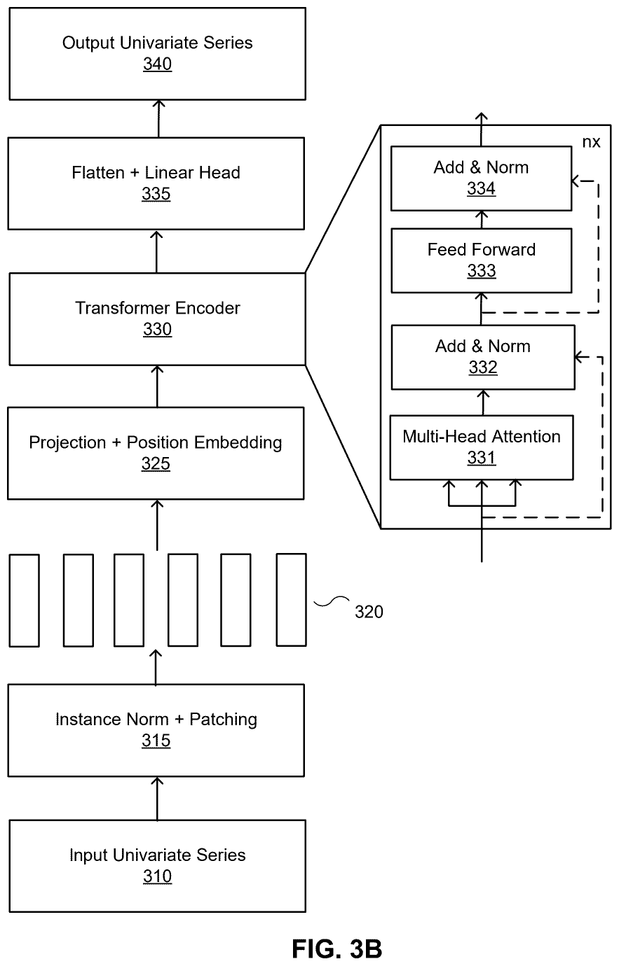

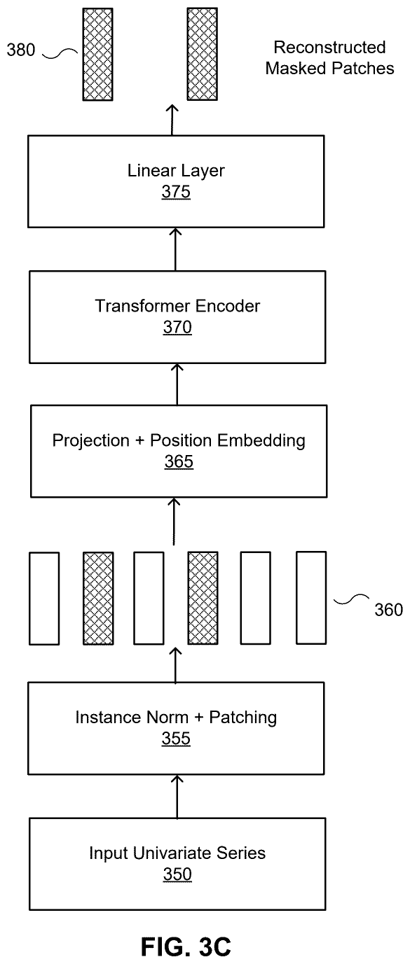

FIGS. 3A through 3C illustrate a GPT-like, transformer architecture that may be adapted for use with time series and time stamped contextual data (e.g., news headlines), according to one embodiment. In FIG. 3A, a collection of multivariate time series samples 302 with look-back window L: (x₁, . . . , x_{L}), where each xₜ at time step t is a vector of dimension M. In general, the goal of a predictive model is to forecast T future values (x_{L+1}, . . . , x_{L+T}). time series are provided as input that are channel-independent (meaning that while they are provided to the same transformer, they are processed independently). Thus, the set of time series can be represented as x∈ [symbol] ^{M×L}. The collection of multivariate time series samples 302 is separated out to get a set of M univariate sample 304, represented mathematically as xⁱ∈ [symbol] ^{1×L}, i=1, . . . , M.

Each univariate sample 304 is fed independently into the transformer backbone 305 to generate a corresponding prediction, \hat{x}⁽ⁱ⁾=(\hat{x}_{L+1}⁽ⁱ⁾, . . . \hat{x}_{L+T}⁽ⁱ⁾)∈ [symbol] ^{1×T}. The predictions 306 can [symbol] be concatenated to produce the final predictions set 308, represented mathematically as \hat{x}∈ [symbol] ^{M×T}.

The transformer backbone 305 may be trained using supervised learning, semi-supervised learning, or a combination of both approaches. FIG. 3B illustrates an example configuration for a transformer backbone 305 trained using supervised learning, according to one embodiment. In FIG. 3B, the transformer backbone 305 receives a univariate series 310 as input. Instance normalization and patching 315 are applied as preprocessing to the univariate series 310. Instance normalization can help mitigate the distribution shift effect between the training and testing data. Instance normalization normalizes each time series instance x⁽ⁱ⁾ to have zero mean and unit standard deviation. In essence, each x⁽ⁱ⁾ is normalized before patching and the mean and deviation are added back to the output prediction.

Patching divides up the univariate series into a set of patches 320 which may be overlapping or non-overlapping. Each patch in the set 320 has as length, P, and the start of each patch is separated from the start of the previous patch by the stride, S. The end of the original sequence may be padded by S dummy values (e.g., repeats of the last value in the sequence) to prevent the end of the sequence being under-sampled. With the use of patches 320, the number of input tokens can reduce from L to approximately L=S. This means that the memory usage and computational complexity of the attention map are quadratically decreased by approximately a factor of S. Thus, when constrained on the training time and GPU memory, patch design can allow the model to see longer historical sequences, which can significantly improve the forecasting performance.

Projection and position embedding 325 are applied to the set of patches 320 before being provided to the transformer encoder 330. Specifically, the patches are mapped to the latent space of the transformer, which has D dimensions. The mapping may be done my trainable linear projection, Wₚ∈ [symbol] ^{D×P}. A learnable additive position coding, Wₚₒₛ∈ [symbol] ^{D×N}, may also be applied to monitor the temporal order of the patches: x_{d}⁽ⁱ⁾=Wₚxₚ⁽ⁱ⁾+Wₚₒₛ, where x_{d}⁽ⁱ⁾∈ [symbol] ^{D×N} is the input that is provided to the transformer encoder 330.

The transformer encoder 330 processes the input with n heads of a multi-head attention block 331. The transformer encoder 330 may also include a first addition and normalization layer 332 (e.g., a BatchNorm layer), a feed forward network 333, and a second addition and normalization layer 332 (e.g., a BatchNorm layer). The output from the transformer encoder 335 may be denoted z⁽ⁱ⁾∈ [symbol] ^{D×N}. A flatten layer with a linear head 335 may be used to obtain the prediction result, \hat{x}⁽ⁱ⁾, which is a univariate series 340 (which may then be concatenated with other univariate series to form a multivariate series prediction).

In one embodiment, the training module 230 uses the mean squared error as a loss function to quantify discrepancies between predictions and ground truth for training data. The training module may gather the loss in each channel and average the losses over M time series to get an overall objective loss that can then be used to update the model (e.g., using backpropagation). It should be appreciated that other loss functions may be used.

FIG. 3C shows an example configuration of the transformer backbone 305 trained using semi-supervised learning. As in FIG. 3B, a univariate input series 350 is normalized and patched 355 to generate a set of patches 360. A subset of the patches 360 (e.g., a randomly selected subset) are set to zero (or some other value selected to indicate an unknown value). Generally, the set of patches 360 are non-overlapping in this context so that information about the true values of the subset of patches is not included directly in the adjacent patches.

The set of patches are subject to projection and position embedding 365, as described with reference to FIG. 3B, and processed by the transformer encoder 370. However, in the configuration shown in FIG. 3C, the transformer encoder 370 is trained to predict (after passing its output through a linear layer 375), the original values of the subset of patches.

In various embodiments, the model architecture that expects to receive numerical data is modified to enable text data (e.g., news headlines) or other types of non-numerical input to be provided. The following paragraphs describe two such embodiments by way of example.

In the first embodiment, the representation generated by the transformer backbone is expanded to accommodate representations of the text input. At a high level, the three steps in the prediction architecture shown in FIGS. 3A-C are:

$${x}^{( i )} ∈ {R}^{D \cdot N} \to [ Transformer Encoder ] \to {z}^{( i )} ∈ {R}^{D \cdot N} \to [ Flatten + Linear Head ] \to {\hat{x}}^{( i )} ∈ {R}^{1 \times T} .$$

Where D is the embedding dimension and N is the number of patches. Note that the input dimension of the linear head in the final step is D·N.

The flattened z⁽ⁱ⁾ vector, which is in R^{D·N}, may be augmented with additional dimensions corresponding to the text. Suppose that the text associated to each time series consists of a string of tokens:

y=[y[0]y[1]y[2], . . . ,y[ [symbol] ]]

Each token with a timestamp:

TS(y)=[TS[0]TS[1]TS[2], . . . ,TS[ [symbol] ]]

The timestamps monotonically but not strictly increase. In other words, with the timestamp of y[i] being TS[i], then for i<j:

TS[i]≤TS[j].

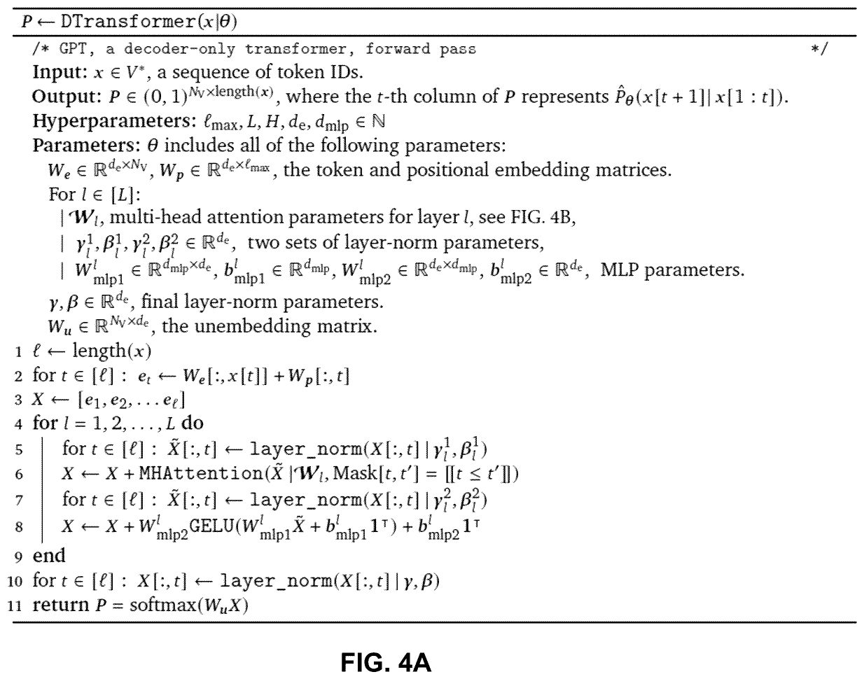

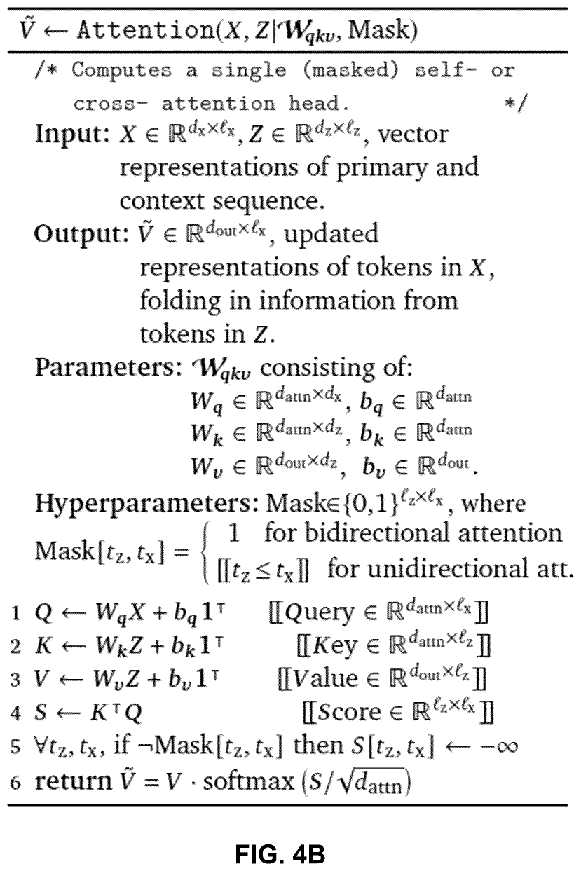

Any sequence of tokens with associated timestamps may be referred to as a timestamped token sequence of length [symbol] . The string of tokens y may be passed through a “GPT” decoder-only transformer, similar to the approach shown in FIGS. 4A and 4B, but without line 11 from FIG. 4A and where y and Y correspond to x and X, respectively, in FIGS. 4A and 4B, in which the unembedding matrix and softmax for next-token prediction are defined. In other words, y is transformed into Y, the output of line 10 of the algorithm shown in FIG. 4A. Note that
1) Y∈R^{d}^{ₑ}^{×len(y)}.
2) Y[:,:k], the slice of Y up to k position, depends only on information from y[:k], because of the masking used in the self-attention (the same reason that GPT is a causal model which can be used for next-token prediction, as in the standard setup of the algorithm shown in FIG. 4A that includes lines 11).
3) Consequently, Y[:,k]^{T}∈R^{d}^{ₑ} depends only on information from y[:k].

In brief, let t_{L} be the timestamp of the last element in the lookback window. Let k[t_{L}] be the last (rightmost) position in the time-stamped token sequence such that TS[k[t_{L}]]≤t_{L}. Then concatenate Y[:,k(t)]^{T} to the flattened z⁽ⁱ⁾ vector, which results in a vector in R^{D·N+d}^{ₑ} that incorporates representations of the input text data. To accommodate this, the input dimension of the linear head is also modified from D·N to D·N+dₑ.

In the second embodiment, lines 1-10 of the algorithm shown in FIG. 4A are used to transform y into Y, similar to the first embodiment. However, the step

$${x}^{( i )} ∈ {R}^{D \cdot N} \to [ Transformer Encoder ] \to {z}^{( i )} ∈ {R}^{D \cdot N}$$

is modified by allowing the “transformer encoder” to pay attention to Y with appropriate masking. For example, this can be achieved by the following algorithm:

```
for i = 1, 2, . . . , L_{dec} do
  X ← X + MHAttention(X| [symbol] , Mask[t, t′] ≡ [[t ≤ t′]])
  for t ∈ [ [symbol] ]:X[:, t] ← layer_norm(X[:, t]γₗ³, βₗ³)
  $X ← X + MHAttention ( X , Y \vert , Mask [ {t}_{Y} , {t}_{X} ] ≡ [ [ TS [ {t}_{Y} ] \leq TS [ {t}_{X} ] ] ] )$
  for t ∈ [ [symbol] ]:X[:, t] ← layer_norm(X[:, t]|γₗ⁴, βₗ⁴)
  X ← X + Wₘₗₚ₄^{l} ReLU(Wₘₗₚ₃^{l} X + bₘₗₚ₃^{l} 1^{T}) + bₘₗₚ₄^{l} 1^{T}
  for t ∈ [ [symbol] ]:X[:, t] ← layer_norm(X [:, t]|γₗ⁵, βₗ⁵)
end
```

Regardless of the specific embodiment used to encode the text, the encoding of the text into a format that can be entered into the transformer backbone enables the training module 230 to train transformer backbone on training data that includes both times series and time stamped text (e.g., news headlines). It should be appreciated that the model may be adapted to accept contextual data of any modality by defining a tokenization algorithm for the particular modality that converts the input into an ordered set of time-stamped tokens. A limitation of GPT-like models is that only a certain context window can be processed because of the quadratic scaling of self-attention. To accommodate this, a filtering, summarization, and/or compression pipeline may be used to determine what contextual text information to provide to the model.

The validation module 240 applies the trained model to a validation data set that was not used during training for verify that the model training was successful. For example, in the case of a model trained on historical market data, the model may be applied to more recent data for the same market (e.g., current market data) to see if it accurately reproduces the next day's price for assets for one or more assets of interest. Depending on the ultimate use case, a threshold accuracy in terms of the number of predictions that are considered correct and/or how close to the true value a prediction has to be to be considered correct may be defined. If the trained model achieves the desired accuracy, it may be considered successfully trained and made available for deployment. Conversely, if the desired accuracy is not obtained, the model may be retrained (e.g., using different hyperparameters and/or different training data).

The prediction module 250 applies the trained model to unlabeled time series data and associated contextual data to predict other values (e.g., the next value or the next five values, etc.) of the time series. For example, in an embodiment applied to market data, the ticker values for a set of stocks for a previous time period (e.g., the last month or year) may be provided along with current news headlines and the model may predict a price for some or all of the stocks for the end of the current day, the next day, or the next five days, etc. Similarly, using a configuration similar to the one shown in FIG. 3C, values that are missing from a time series may be filled in. For example, the power usage for cities for which current data is unavailable may be predicted from the power usage of other cities (and associated text data such as news headlines) to aid in decisions on shipments of goal, gas, and other fuels to storage facilities near each city. It should be appreciated that there are a wide range of use cases where predicting values in time series in beneficial.

The datastore 260 includes one or more computer-readable media that store data and software used by the server 110. For example, the parameterized model, time series, and timestamped news headlines may all be stored in the datastore 260. Although the datastore 260 is shown as a single entity within server 110, it may be divided into multiple parts, some or all of which may be accessed remotely (e.g., via the network 170).

### Example Method

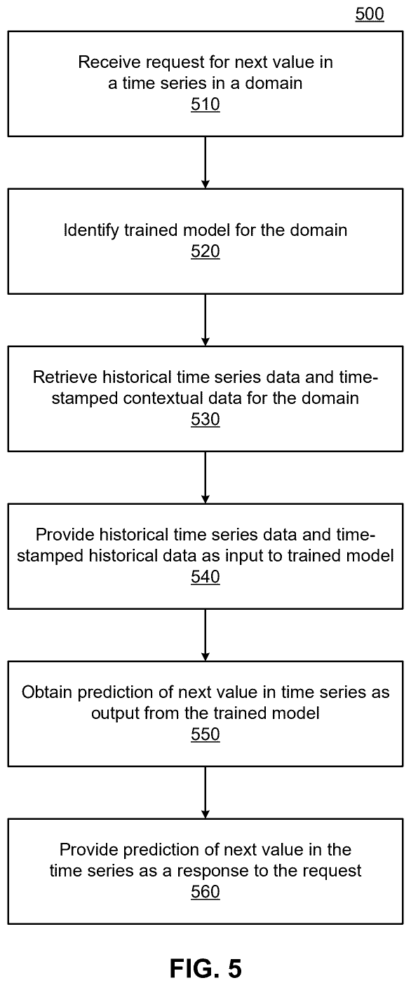

FIG. 5 illustrates a method 500 for predicting one or more future time series values, according to one embodiment. The steps of FIG. 5 are illustrated from the perspective of a client device 140 performing the method 500. However, some or all of the steps may be performed by other entities or components. In addition, some embodiments may perform the steps in parallel, perform the steps in different orders, or perform different steps.

In the embodiment shown in FIG. 5, the method 500 begins with the client device 140 receiving 510 a request for the next value in a time series. The request may be received 510 from a user via user input or another computing device (e.g., via an API call). The client device 140 identifies 520 a trained model. As described previously, the trained model may be a foundation model that was trained with a decoder head that is fine tuned (in combination with the foundation model) to predict values for (or related to) the specific time series of interest.

The client device 140 retrieves 530 historical time series data and time-stamped contextual data and provides 540 the retrieved data as input to the trained model. The trained model generates a prediction of the next value in the time series (or a value related to the time series) that is obtained 550 by the client device 140. The generated prediction is provided 560 as a response to the request. For example, the prediction may be displayed on a screen of the client device 140 or provided to another computing device or routine that requested the prediction for use as part of another process.

### Computing System Architecture

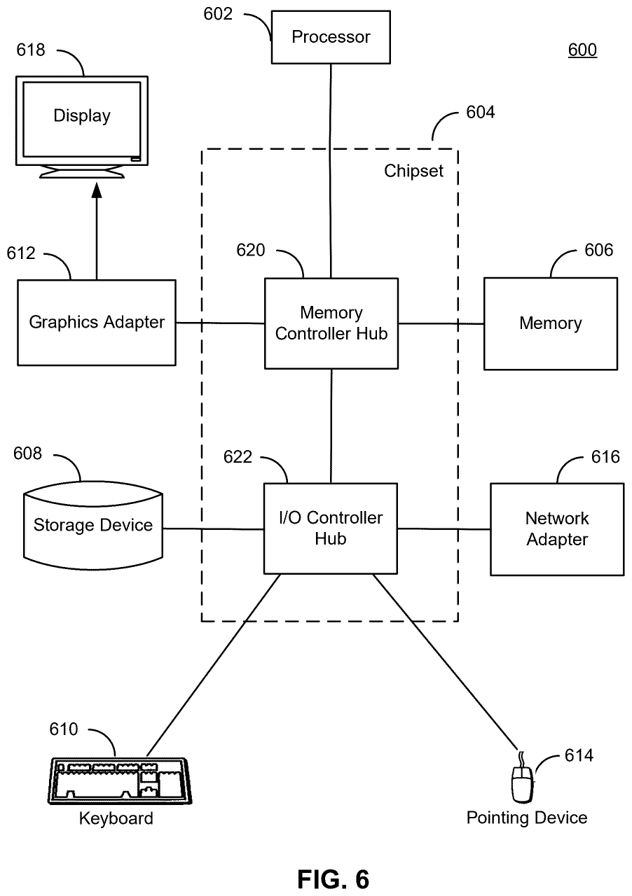

FIG. 6 illustrates an example computer 600 suitable for use as the server 110 or a client device 140. The example computer 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touchscreen, or other type of pointing device, and is used in combination with the keyboard 610 (which may be an on-screen keyboard) to input data into the computer system 600. The graphics adapter 612 displays images and other information on the display 618. The network adapter 616 couples the computer system 400 to one or more computer networks (e.g., network 170). The types of computers used by the entities of FIGS. 1 and 2 can vary depending upon the embodiment and the processing power required by the entity. Furthermore, the computers can lack some of the components described above, such as keyboards 610, graphics adapters 612, and displays 618.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A method for predicting a next value in a time series, the method comprising:
receiving a request for a value related to a time series;
identifying a trained model;
retrieving historical time series data and time-stamped information that is related to the time series data, the time-stamped information being of a different modality to the time series data;
providing the historical time series data and the time-stamped data as input to the trained model;
obtaining, as output from the trained a model, a prediction of the value related to the time series; and
providing the prediction of the value as a response to the request.

2. The method of claim 1, wherein the trained model has a transformer architecture.

3. The method of claim 1, wherein the time-stamped information is provided as input to the trained model by dividing the timestamped information into a token sequence of length [symbol] , each token having a timestamp.

4. The method of claim 1, wherein the time series comprises prices for one or more assets over a preceding time period and the different modality of the time-stamped information is text.

5. The method of claim 4, wherein the timestamped information comprises news headlines.

6. The method of claim 1, wherein the trained model was trained using supervised learning, semi-supervised learning, or both.

7. The method of claim 1, wherein the request is received from a client device via an application programming interface (API) and providing the response comprises sending the prediction of the value to the client device.

8. The method of claim 1, wherein the historical time series data comprises one or more multivariate series, the method further comprising:
dividing the one or more multivariate series into a plurality of univariate series; and
dividing each univariate series into patches, each patch corresponding to a time range, wherein the patches are embedded are provided as input to an encoder of the trained model.

9. The method of claim 8, further comprising performing instance normalization on the univariate series such that each univariate series has a zero mean and unit standard deviation.

10. The method of claim 8, wherein at least some of the patches for a univariate series of the plurality of univariate series have overlapping time ranges.

11. The method of claim 1, wherein providing the historical time series data and the time-stamped information as input to the trained model comprises fusing the time series data and the time-stamped information.

12. The method of claim 11, wherein the fusing comprises:
applying cross-attention between the time series data and the time-stamped information within a transformer; and
concatenating representations of the time series data and the time-stamped information in a vector space after application of the transformer.

13. A non-transitory computer-readable medium comprising a stored neural network, the neural network configured to:
receive as input information generated by fusing time series data and time-stamped information that is related to the time series data the time-stamped information being of a different modality to the time series data; and
produce as output a prediction of a future value in the time series data.

14. The non-transitory computer-readable medium of claim 13, wherein the fusing comprises concatenating representations of the time series data and the time-stamped information in a vector space after application of a transformer.

15. The non-transitory computer-readable medium of claim 13, wherein the fusing comprises applying cross-attention between modalities within a transformer.

16. A computing system for predicting a next value in a time series, the computing system comprising:
one or more processors; and
one or more non-transitory, computer-readable medium storing instructions that, when executed by some combination of the one or more processors, cause the computing system to perform operations including:
receiving a request for a value related to a time series;
identifying a trained model;
retrieving historical time series data and time-stamped information that is related to the time series data, the time-stamped information being of a different modality to the time series data;
providing the historical time series data and the time-stamped data as input to the trained model;
obtaining, as output from the trained a model, a prediction of the value related to the time series; and
providing the prediction of the value as a response to the request.

17. The computing system of claim 16, wherein the time-stamped information is provided as input to the trained model by dividing the timestamped information into a token sequence of length [symbol] , each token having a timestamp.

18. The computing system of claim 16, wherein the time series comprises prices for one or more assets over a preceding time period and the different modality of the time-stamped information is text, the time-stamped information including news headlines.

19. The computing system of claim 16, wherein the historical time series data comprises one or more multivariate series, the operations further comprising:
dividing the one or more multivariate series into a plurality of univariate series; and
dividing each univariate series into patches, each patch corresponding to a time range, wherein the patches are embedded are provided as input to an encoder of the trained model.

20. The computing system of claim 16, wherein providing the historical time series data and the time-stamped information as input to the trained model comprises fusing the time series data and the time-stamped information, the fusing comprising:
applying cross-attention between the time series data and the time-stamped information within a transformer; and
concatenating representations of the time series data and the time-stamped information in a vector space after application of the transformer.
